(19) United States
(12) Patent Application Publication
(10) Pub. No.: US 2012/0305543 A1
(43) Pub. Date: Dec. 6, 2012

(54) HEATING OF PIPE SECTIONS

(75) Inventors: Robert Louis van Hoften, Leiden (NL); Dirk Victor Maria Vandoninck, Kalmthout (BE)

(73) Assignee: HEEREMA MARINE CONTRACTORS NEDERLAND B.V., Leiden (NL)

(21) Appl. No.: 13/472,849

(22) Filed: May 16, 2012

Related U.S. Application Data
(60) Provisional application No. 61/492,114, filed on Jun. 1, 2011.

(30) Foreign Application Priority Data
Jun. 1, 2011 (NL) 2006881

(51) Int. Cl. H05B 6/00

(52) U.S. Cl. 219/618

(57) ABSTRACT

A heating a pipe section on board a pipe-laying vessel includes at least one coil constructed to be arranged in a position surrounding the pipe section, the at least one coil being constructed to guide a strong electric current from at least one current source which—in use—is coupled to the at least one coil, where the at least one coil has a coil length which corresponds substantially to the length of the pipe section which is to be heated.

### CROSS-REFERENCE TO RELATED APPLICATIONS

This application claims the benefit of U.S. Provisional Application, No. 61/492,114, filed Jun. 1, 2011, and of Netherlands Application No. 2006881, filed Jun. 1, 2011, the contents of all of which are incorporated by reference herein.

### FIELD OF THE INVENTION

The present invention relates to a device for pre-heating a pipe section on board a pipeline laying vessel and to a method of pre-heating a pipe section on board a pipeline laying vessel.

### DESCRIPTION OF THE PRIOR ART

In the field of marine pipelay, pipelines are laid on the seabed by a pipeline laying vessel. Generally, consecutive pipes are welded to a pipeline which is suspended by its end from the pipeline laying vessel. The pipeline laying operation may be performed in a so called “J-lay mode” or in “S-lay mode”. Other, less common modes also exist. The pipeline is formed by each time connecting a pipe to the pipeline and lowering the pipeline to the seabed, while at the same time moving the pipeline laying vessel forward.

It is generally desirable to ensure that the pipeline laying process is fast, reliable and results in a high quality pipeline.

The pipes which are connected to the pipeline are generally coated with a coating which extends along a substantial part of the length of the pipes. Mechanical protection, anti corrosion protection and/or thermal insulation are generally functions of the coating. The coating may also have other functions, such as to protect the pipe against any aggressive action of the sea water. This coating is generally not present near the ends of the pipes, because the welding device which welds the pipe to the pipeline needs direct access to the weld zone and the presence of a coating at this location would obstruct the welding and potentially contaminate the weld pool. In the case of thermal insulation coating, the thickness of the coating layer can prohibit the welding or inspection equipment to be placed on the pipe.

Prior to connecting the pipe to the pipeline, the ends to be joined are lined up in close proximity of each other. The ends of the pipe and pipeline may require heating before welding can commence. This is well known in the art as pre-heating. Reasons for pre-heating may include reduction of the risk of hydrogen cracking, reduction of the hardness of the weld heat affected zone and reduction of shrinkage stresses during cooling, as well as improvement of the distribution of residual stresses.

Preheat is generally applied to a section that extends at least 75 mm to each side of the weld location, but different dimensions may also occur.

After the pipe is connected to the pipeline, a pipe section remains in the region of the weld which is without coating. This pipe section often has to be coated after the weld is performed.

This coating process is generally referred to as field joint coating (FJC), because it relates to the coating of a joint which is made in the field, as opposed to the coating process of the rest of the pipe, which is carried out on shore.

The distance over which the pipe section is to be coated in the FJC process may lie in the order of 1-2 m. A greater distance may also be possible.

Prior to the coating of the pipe section, the pipe section itself is generally pre-heated. The pre-heating allows the subsequent coating material to become attached to the pipe section. The coating material which contacts the pipe section generally melts and forms a connection with the pipeline.

Pre-heating devices of the prior art use an induction coil, which is coupled to a source of electric current. The coil surrounds the pipe section and is moved back and forth (in J-lay: up and down) over the length of the pipe section which is to be heated. This movement is referred to as “scanning”. After a given period of time, the entire pipe section has reached a desired temperature and the coating process can commence.

The present invention relates to an improved device for heating the pipe section.

### SUMMARY OF THE INVENTION

According to an aspect of the invention, a heating device is provided for heating a pipe section on board a pipe-laying vessel, the heating device comprising at least one coil constructed to be arranged in a position surrounding the pipe section, the at least one coil being constructed to guide a strong electric current from at least one current source which—in use—is coupled to the at least one coil, wherein the at least one coil has a coil length which corresponds substantially to the length of the pipe section which is to be heated.

With the heating device according to the invention, a relatively fast heating process is possible. Because the at least one coil extends over substantially the entire length of the pipe section which is to be heated, the entire pipe section can be heated at a same time.

Typically, the heating device will be used prior to welding or prior to application of field joint coating on the pipe section.

In an embodiment, the heating device according to the invention is also efficient. Because the entire length is heated at the same time, heat loss is relatively low.

In an embodiment, at least one coil is provided which relatively accurately follows the contour of the pipe section. This allows the coil to be positioned closer to the wall of the pipe section, thereby decreasing the gap between the inner side of the coil and the wall of the pipe section. This also increases the efficiency of the heating process. This is in particular an advantage when the pipe section comprises a collar.

In an embodiment, the heating device is configured to be held stationary relative to the pipe section at least in the longitudinal direction of the pipe section.

In an embodiment, the heating device comprises a plurality of coils, each coil surrounding a respective part of the pipe section, wherein a total length of the plurality of coils corresponds substantially to the length of the pipe section which is to be heated.

In an embodiment, each coil is coupled to an independent current source such that in use different electric currents can be guided through the coils. This allows more heat to be applied in one region than in another region of the pipe section, or to apply heat to a limited part of the pipe section.

In an embodiment, the heating device comprises three or more coils.

In an embodiment, at least a first coil is constructed to surround a pipe section adjacent a collar on the pipe section, wherein at least a second coil is constructed to surround a pipe section adjacent an opposite side of the collar, and wherein at least a third coil is constructed to surround a pipe section including the collar.

In this way, the pipe section with the collar can be heated more efficiently than with induction heaters according to the prior art. The coil which is constructed to extend about the collar has a greater diameter than the other coils.

In an embodiment, the at least one coil is mounted to a frame which is movable from a remote position to a position close to the pipeline. This is a practical way of providing the coils to the pipe section. This embodiment allows the heating device to be moved away from the pipe section quite quickly after the heating process, so that the coating process may start directly and less heat is lost.

In an embodiment, the frame that moves the heating coil from its storage position to the operating position and back to the storage position, can be of a simple design as movement of the coil may only be required in one plane, i.e. between the storage position and the operating position. In this embodiment, the frame is configured to move in one plane only.

In different circumstances, it may be required to position the coil with six degrees of freedom.

In an embodiment, the at least one coil comprises:
at least a first coil part and a second coil part,
a hinge connecting the first and second coil part and allowing the first and second coil part to be opened to positioned the pipe section between the first and second coil part.

In an embodiment, the heating device comprises a connector allowing the first and second coil parts to be connected to one another in order to close an electric current loop around the pipeline.

Such a coil can be conveniently positioned around the pipeline.

In an embodiment, the heating device comprises two half shells connected at the pivot side with a flexible electrical connection which guides the current past the hinge connection. Each half shell comprises conductors which extend orbitally and which are connected at the open end by an end conductor which extends in the axial direction and which connects two adjacent orbital conductors. In use, the current travels through the orbital conductor of the half shell until the unconnected side is reached. The current then travels through the end conductor and lowers axially and returns parallel back to the hinge connection through the adjacent orbital conductor, the flexible electrical connection at the hinge connection and the orbital conductor in the other half shell to the unconnected side of the other half shell. Here, the current lowers again axially through an end conductor at this open end. This is repeated until the required height is reached.

For a J-lay system the at least one coil is constructed to be placed around a substantially vertical pipeline.

The present invention also relates to a pipeline laying vessel comprising a heating device according to the invention.

The present invention also relates to a method of heating a pipe section on board a pipe-laying vessel, the method comprising:
providing a heating device for heating a pipe section on board a pipe-laying vessel prior to coating of said pipe section, the heating device comprising at least one coil constructed to be arranged in a position surrounding the pipe section, the at least one coil being constructed to guide a strong electric current from at least one current source which—in use—is coupled to the coil, wherein the at least one coil has a coil length which corresponds substantially to the length of the pipe section which is to be heated, and
heating the pipe section by guiding a strong electric current around the pipe section through the at least one coil, wherein the at least one coil is held substantially stationary in the direction of a main axis of the pipe section during the heating of the pipe section.

The method provides substantially the same benefits as the heating device according to the invention.

In an embodiment, the heating device comprises at least a first coil and a second coil, the method comprising guiding a different electric current through the second coil than through the first coil.

In an embodiment, the heating is carried out prior to the coating of said pipe section.

In an embodiment, the heating is carried out prior to the welding of said pipe section.

### BRIEF DESCRIPTION OF THE FIGURES

The previous and other features and advantages of the present invention will be more fully understood from the following detailed description of exemplary embodiments with reference to the attached drawings.

FIG. 1 shows a sectional view from the side of the heating device according to the invention.

FIG. 2 shows a top view of the heating device according to the invention.

FIG. 3 shows a side view of a heating device according to the invention.

FIG. 4 shows a perspective view of the heating device according to the invention in an open condition.

FIG. 5 shows a perspective view of the heating device according to the invention in a closed condition.

FIG. 6A shows a top view of an example of an arrangement of the coils.

FIG. 6B shows a side view of an example of an arrangement of the coils.

FIG. 7 shows a side of the heating device according to the invention supported by a movable arm.

### DETAILED DESCRIPTION OF THE INVENTION

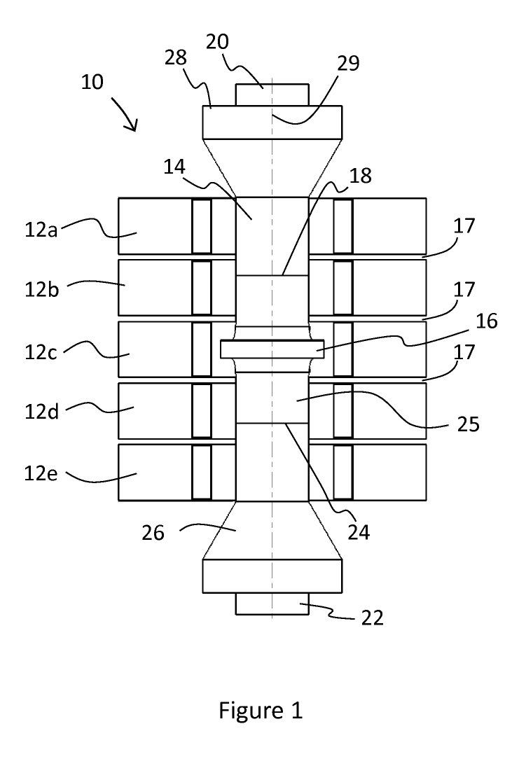

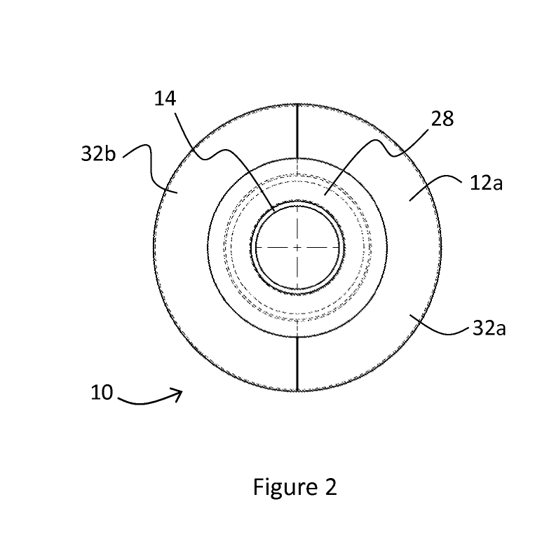

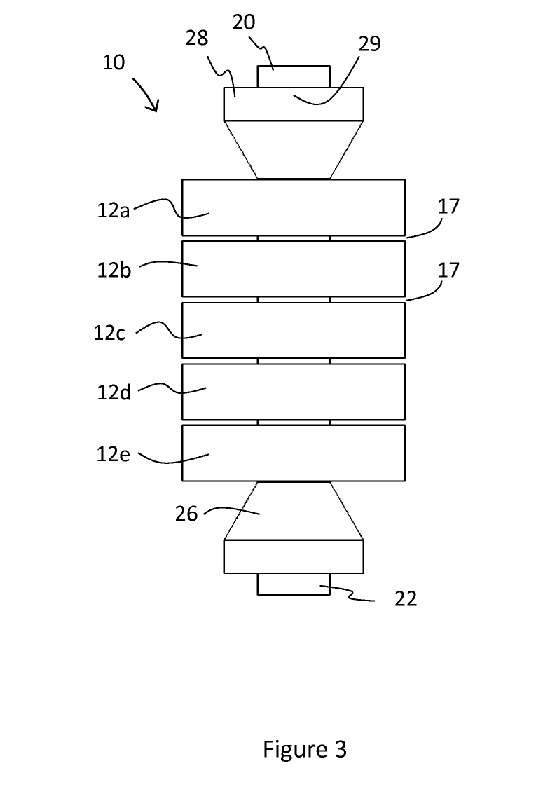

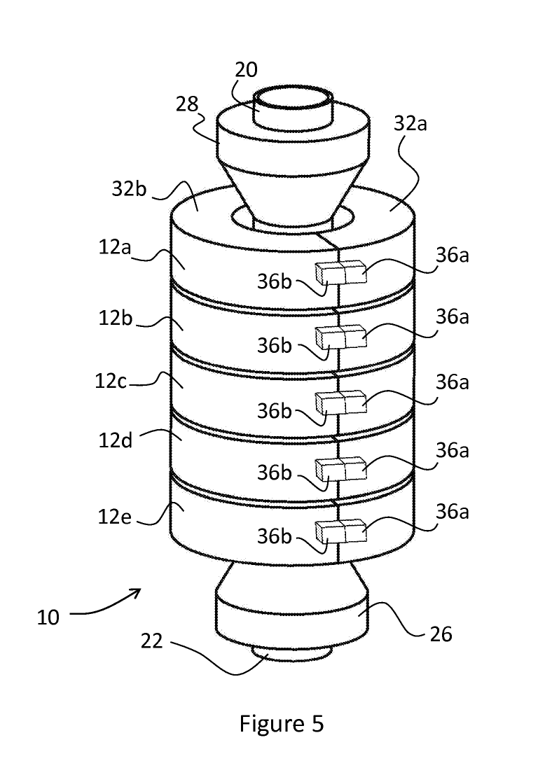

Turning to FIGS. 1-5, a heating device 10 according to the invention is shown. The heating device 10 comprises a number of coils 12a, 12b, 12c, 12d, 12e which are configured to be placed around a pipe section 14. The coils are coupled to a source of electric current. The current may be an alternating current.

The coils are located adjacent one another, and can engage one another or be spaced from one another with a relatively small gap 17.

The pipe section 14 which is to be heated generally is the part of a pipeline where a pipe 20 has been welded to a pipeline 22 which is suspended from a pipeline laying vessel.

The pipe and the pipeline are aligned and define a common longitudinal axis 29.

The pipe section 14 comprises a collar 16 and a weld zone 18 where the pipe 20 has previously been welded to the suspended pipeline 22. The pipe section 14 comprises both a part of the pipeline 22 and a part of the pipe 20.

A weld line 24 can be identified where the collar piece 25 has previously been welded to the pipe that forms the end of the pipeline 22.

It is also possible that the device is used prior to welding of the pipe 20 to the pipeline 22. In that case, the pipe 20 is positioned in an end-to-end relation ship with the pipeline 22, and the pipe section 14 comprises two separate parts.

The suspended pipeline 22 is provided with a coating 26. Although only a small length of coating 26 is shown for the pipeline 22, a skilled person will understand that the coating 26 around the pipeline 22 generally extends over the entire pipeline 22, i.e. all the way down to the seabed and up to the end of the pipeline 22.

The pipe 20 is also provided with coating 28. Only a small portion of the coating 28 is shown, but the coating extends over a large part of the pipe 20.

Between the coating 26 and the coating 28, a non-coated pipe section 14 with a length L extends which is to be provided with coating. To this end, the non-coated pipe section 14 needs to be pre-heated and subsequently coated.

The coils 12a-12e extend over a length L which substantially corresponds to the length L of the uncoated pipe section 14. In use, the coils 12a-12e can heat the complete pipe section 14 without having to be moved up and down, i.e. in the longitudinal direction of the pipe section.

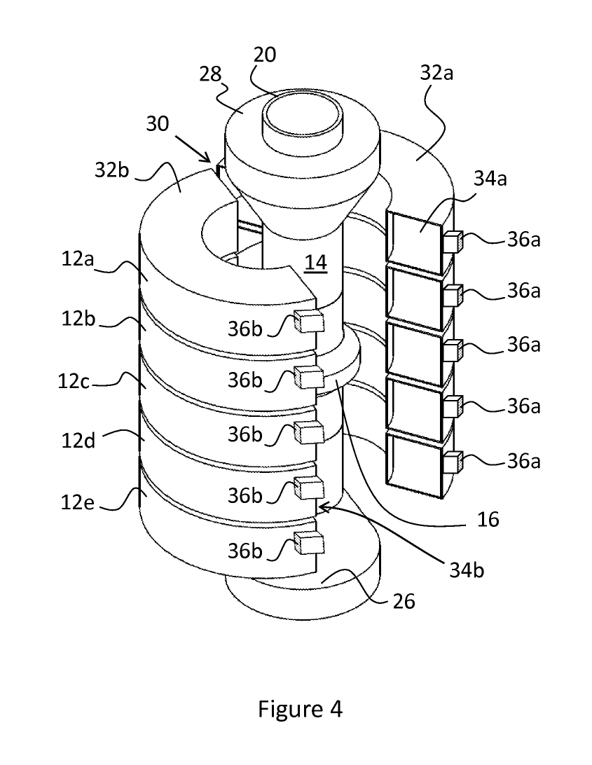

Turning to FIG. 4, it can be seen that hinges 30 are provided on one side of the coils 12a, 12e. The hinges 30 divide each coil in two parts 32A, 32B and allow the coils 12a-12e to pivot into an open position. In the open position, the coils 12a-12e can be positioned around the pipe section 14.

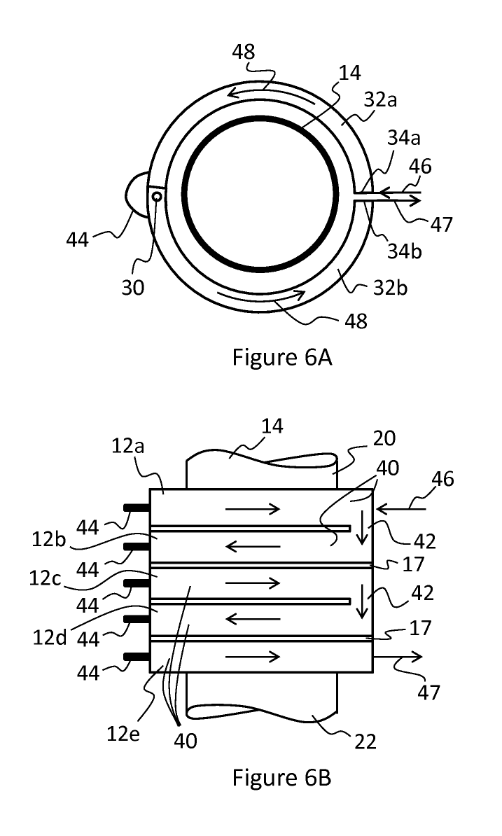

Next the, coils 12a-12e are closed. Connectors 36a 36b at the ends 34a, 34b of the coil parts 32a, 32b allows the ends 34a, 34b to be connected to one another. As will be discussed with respect to FIGS. 6A and 6B, in another embodiment, connectors are not used.

A strong electric current is then guided through the coils 12a-12e. This heats up the pipe section 14. The temperature may be raised to a value that typically lies between 100 and 250 degrees Celsius

During the heating of the pipe section 14, the heating device 10 is kept stationary relative to the pipe section 14.

Because the coil length corresponds substantially to the length of the pipe section which is to be heated, in use the at least one coil can be held substantially stationary in the direction of a main axis of the pipe section during heating of the pipe section, while heating substantially the entire pipe section 14. This results in a relatively fast heating process with relatively little heat loss.

The current flowing through each coil 12a-12e can be individually set. In the case when an element is present in the pipeline with properties differing from the nominal pipe properties, for instance collar 16 as shown in FIG. 1, the coil 12c can be set to generate more heat than the other coils in order to achieve uniform heating of the pipe section to be connected or coated.

The same heating device may be used both for pre-heating the pipe section prior to the welding operation as for pre-heating the pipe section prior to the coating operation.

FIGS. 6A and 6B show an arrangement of the coils which does not use a connector. The coils 12a-12e each comprise at least one conductor 40 which in use extends orbitally around the pipe section 14.

At the end 34b, an end conductor 42 is provided which extends parallel to the main longitudinal axis 29 and which electrically connects a first coil 12a with a second coil 12b.

At the hinge connection 30, flexible electrical connections are provided to guide the electric current past the hinge connection 30.

In use, the current enters coil 12 via a current supply line 46 at end 34a. The current flows through coil 12a in the direction of arrow 48 around the pipe section 14. At the hinge connection 30, the current flows through the flexible electric connection 44 from one half 32a to the other half 32b. The current continues to flow through conductor 40 of coil 12a in direction 48 around the pipe section 14. At the end 34b, the current flows from one coil 12a via the end conductor 42 to another coil 12b. The direction of the current then reverses, and the current flows through conductor 40 of coil 12b back to the first end 34a. Here, the current flows through an end conductor 42 (not shown) again to the next coil 12c. This goes on until the current finally leaves the heating device through the current out 47. Of course, a skilled person will understand that an electric current changes direction multiple times during the heating process, so the above mentioned route reverses multiple times.

The conductor may be a single, relatively large metal conductor or may comprise multiple, smaller metal wires packed together.

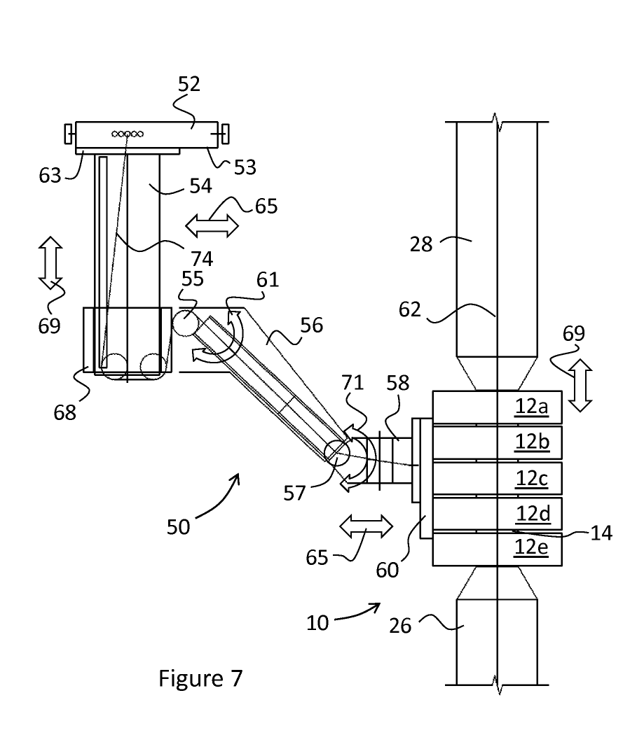

Turning to FIG. 7, the heating device 10 is shown mounted to a movable frame 50. The movable frame 50 comprises a base 52 which is mounted to the ceiling or floor of a work station on board a pipeline laying vessel. The movable arm comprises a first arm segment 54, a second arm segment 56 and a third arm segment 58.

The first segment 54 is coupled to the base 52 via a rail 53. A cart 63 is constructed to move over said rail 53. This allows a horizontal movement of the first arm segment 54 in a direction 65 toward and away from a firing line 62 along which a pipeline is paid out from the pipeline laying vessel.

A second cart 68 is mounted to the first arm segment 54 and constructed and arranged to slide or roll up and down over said first arm segment in the direction of arrow 69. This allows vertical movement of the heating device 10 relative to the pipe section 14.

The second arm segment 56 is coupled to the first segment 54 via a first hinge 55. This allows pivoting of the second arm segment relative to the first arm segment 54 in the direction of arrow 61.

The third arm segment 58 is coupled to the second arm segment 56 via a second hinge connection 57. This allows pivoting of the third arm segment 58 relative to the second arm segment 56 in the direction of arrow 71.

The third arm segment 58 comprises a mount plate 60 to which the coils 12a-12e are mounted.

In use, the coils 12a-12e are positioned around the pipe section with the movable frame 50, prior to the heating of the pipe section. When the coils are in the correct position, the heating commences. The pipe section is heated until the required temperature is reached. Next, the coils 12a-12e are move away from the pipe section 14, do that the pipe section 14 becomes accessible again. The coils 12a-12e are move to a storage position remote from the firing line 62.

The coils 12a-12e are movable in a horizontal direction, movable in a vertical direction and pivotable in order to meet an inclination of the pipe section 14, relative to the work station. Thus, the coils 12a, 12e can be positioned around the pipe section in every possible orientation. The coils 12a-12e can be positioned accurately.

The arm also houses an electric cable 74 which extends from the base to the coils and which is constructed and arranged to provide the coils 12a-12e with electric current.

It will be obvious to a person skilled in the art that the details and the arrangement of the parts may be varied over considerable range without departing from the spirit of the invention and the scope of the claims.

1. A heating device for heating a pipe section on board a pipe-laying vessel, the heating device comprising:
at least one coil constructed to be arranged in a position surrounding the pipe section, the at least one coil being constructed to guide a strong electric current from at least one current source which—in use—is coupled to the at least one coil;
wherein the at least one coil has a coil length which corresponds substantially to the length of the pipe section which is to be heated.

2. The heating device of claim 1, wherein the heating device is configured to, in operation, be held stationary relative to the pipe section at least in the longitudinal direction of the pipe section.

3. The heating device of claim 1, wherein the at least one coil has a diameter which varies over the length of the coil.

4. The heating device of claim 1, further comprising:
a plurality of coils, each coil surrounding a respective part of the pipe section;
wherein a total length of the plurality of coils corresponds substantially to the length of the pipe section which is to be heated.

5. The heating device of claim 3, wherein each coil is coupled to an independent current source such that in use different electric currents can be guided through the coils.

6. The heating device of claim 4, wherein the plurality of coils comprises three or more coils.

7. The heating device of claim 4, wherein the plurality of coils have varying diameters.

8. The heating device of claim 4,
wherein at least a first coil is constructed to surround a pipe section adjacent a collar on the pipe section;
wherein at least a second coil is constructed to surround a pipe section adjacent an opposite side of the collar; and
wherein at least a third coil is constructed to surround a pipe section including the collar.

9. The heating device according to claim 7, wherein the coil which is constructed to extend about a pipe section including a collar has a greater diameter than the other coils.

10. The heating device of claim 1, wherein the at least one coil is mounted to a frame which is movable from a remote position to a position close to the pipeline.

11. The heating device of claim 1, wherein the at least one coil comprises:
at least a first coil part and a second coil part; and
a hinge connecting the first and second coil part and allowing the first and second coil part to be opened to positioned the pipe section between the first and second coil part.

12. The heating device of claim 11, further comprising a connector allowing the first and second coil parts to be connected to one another in order to close an electric current loop around the pipeline.

13. The heating device of any of claim 1, wherein the at least one coil is constructed to be placed around a substantially vertical pipeline.

14. A pipeline laying vessel comprising a heating device according to claim 1.

15. A method of heating a pipe section on board a pipe-laying vessel, the method comprising:
providing a heating device for heating a pipe section on board a pipe-laying vessel, the heating device comprising at least one coil constructed to be arranged in a position surrounding the pipe section, the at least one coil being constructed to guide a strong electric current from at least one current source which—in use—is coupled to the at least one coil, wherein the at least one coil has a coil length which corresponds substantially to the length of the pipe section which is to be heated, such that the at least one coil can be held substantially stationary in the direction of a main axis of the pipe section during heating of the pipe section; and
heating the pipe section by guiding a strong electric current around the pipe section through the at least one coil, wherein the at least one coil is held substantially stationary in the direction of a main axis of the pipe section during the heating of the pipe section.

16. The method of claim 15, wherein the heating device comprises at least a first coil and a second coil, the method further comprising:
guiding a different electric current through the second coil than through the first coil.

17. The method of claim 15, wherein the heating is carried out prior to the coating of said pipe section.

18. The method of claim 15, wherein the pipe section heating is carried out prior to the welding of the pipe section a pipe to the pipeline.
